(19) United States
(12) Patent Application Publication
(10) Pub. No.: US 2017/0021473 A1
(43) Pub. Date: Jan. 26, 2017

(54) ABRASIVE ARTICLES

(71) Applicants: SAINT-GOBAIN ABRASIVES, INC., Worcester, MA (US); SAINT-GOBAIN ABRASIFS, Conflans-Sainte-Honorine (FR)

(72) Inventors: Canfeng WANG, Shanghai (CN); Guodong CHEN, Shanghai (CN); Zhen ZHOU, Shanghai (CN); Xiaochao SONG, Shanghai (CN); Andrew B. SCHOCH, Westborough, MA (US)

(21) Appl. No.: 15/197,195

(22) Filed: Jun. 29, 2016

(30) Foreign Application Priority Data
Jun. 29, 2015 (CN) 201510367793.5

(51) Int. Cl. B24D 3/34; B24D 18/00; C09K 3/14

(52) U.S. Cl. CPC B24D 3/34; C09K 3/1436; B24D 18/0009

(57) ABSTRACT

An abrasive article can include a body including a bond material and abrasive particles contained within the bond material. The body can include a filler composition. In a particular embodiment, the filler composition can include at least one filler from a first filler class and at least one filler from a second filler class. The first filler class can include pyrite, potassium sulfate (K2SO4), potassium chloride (KCl), and lime (CaO), and a combination thereof, and the second filler class includes basalt, mullite, zinc sulfide (ZnS), barium sulfate (BaSO₄), potassium titanate (K₂O.nTiO₂) or a combination thereof. In another particular embodiment, the filler composition can include a second filler class including basalt in a content within a range between 1 wt % and not greater than 30 wt % for a total weight of the body. In another particular embodiment, the filler composition can include a second filler class including zinc sulfide (ZnS) in a content within a range between 1 wt % and not greater than 30 wt % for a total weight of the body. In still another particular embodiment, the filler composition can include a second filler class including barium sulfate (BaSO₄) in a content within a range between 1 wt % and not greater than 30 wt % for a total weight of the body. In another particular embodiment, the filler composition can include a second filler class including potassium titanate (K₂O.nTiO₂) in a content within a range between 0.1 wt % and not greater than 30 wt % for a total weight of the body. In another particular embodiment, the filler composition can include a second filler class including mullite in a content within a range between 1 wt % and not greater than 30 wt % for a total weight of the body.

### CROSS-REFERENCE TO RELATED APPLICATION

This application claims priority to Chinese Application No. 201510367793.5, entitled “ABRASIVE ARTICLES”, by Wang et al. filed Jun. 29, 2015, which is assigned to the current assignee hereof and incorporated herein by reference in its entirety.

### BACKGROUND OF THE INVENTION

Field of the Disclosure

The present invention relates in general to abrasive articles, particularly to a bonded abrasive article including fillers.

Description of the Related Art

Bonded abrasive articles can be used for cutting, grinding, or shaping various materials including slab, billet, and ingot. Bonded abrasive articles intended for heavy duty applications are subject to severe conditions, such as high pressure and/or high temperature. Performance of abrasive articles may be affected by the operation conditions. The industry continues to demand improved abrasive articles.

### BRIEF DESCRIPTION OF THE DRAWINGS

Embodiments are illustrated by way of example and are not limited in the accompanying figures.

FIG. 1 includes a graph illustrating properties of a conventional abrasive article and abrasive articles in accordance with embodiments herein.

FIG. 2 includes a graph illustrating other properties of a conventional abrasive article and abrasive articles in accordance with embodiments herein.

FIG. 3 includes a plot of dimension change versus temperature increase of a conventional abrasive article and abrasive articles in accordance with embodiments herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### SUMMARY OF INVENTION

The first aspect of the invention is an abrasive article comprising a body including a bond material; abrasive particles contained within the bond material; and a filler composition contained within the bond material, wherein the filler composition includes at least one filler from a first filler class and at least one filler from a second filler class, wherein: the first filler class includes pyrite, potassium sulfate (K₂SO₄), potassium chloride (KCl), and lime (CaO), and the second filler class includes basalt, mullite, zinc sulfide (ZnS), barium sulfate (BaSO₄), potassium titanate (K₂O.nTiO₂ n=1-10) or a combination thereof.

The second aspect of the invention is an abrasive article comprising a body including a bond material; abrasive particles contained within the bond material; and a filler composition contained within the bond material, wherein the filler composition comprises at least one filler from a first filler class including pyrite, potassium sulfate (K₂SO₄), potassium chloride (KCl), lime (CaO), or a combination thereof, and a second filler class including basalt in a content within a range between 1 wt % and not greater than 30 wt % for a total weight of the body.

The third aspect of the invention is an abrasive article comprising a body including a bond material; abrasive particles contained within the bond material; and a filler composition contained within the bond material, wherein the filler composition comprises at least one filler from a first filler class including pyrite, potassium sulfate (K₂SO₄), potassium chloride (KCl), lime (CaO), or a combination thereof, and a second filler class including zinc sulfide (ZnS) in a content within a range between 1 wt % and not greater than 30 wt % for a total weight of the body.

The fourth aspect of the invention is an abrasive article comprising a body including a bond material; abrasive particles contained within the bond material; and a filler composition contained within the bond material, wherein the filler composition comprises at least one filler from a first filler class including pyrite, potassium sulfate (K₂SO₄), potassium chloride (KCl), lime (CaO), or a combination thereof, and a second filler class including barium sulfate (BaSO₄) in a content within a range between 1 wt % and not greater than 30 wt % for a total weight of the body.

The fifth aspect of the invention is an abrasive article comprising a body including a bond material; abrasive particles contained within the bond material; and a filler composition contained within the bond material, wherein the filler composition comprises at least one filler from a first filler class including pyrite, potassium sulfate (K₂SO₄), potassium chloride (KCl), calcium carbonate (CaCO₃), or a combination thereof, and a second filler class including potassium titanate (K₂O.nTiO₂ n=1-10) in a content within a range between 0.1 wt % and not greater than 30 wt % for a total weight of the body.

The sixth aspect of the invention is an abrasive article comprising a body including a bond material; abrasive particles contained within the bond material; and a filler composition contained within the bond material, wherein the filler composition comprises at least one filler from a first filler class including pyrite, potassium sulfate (K₂SO₄), potassium chloride (KCl), calcium carbonate (CaCO₃), or a combination thereof, and a second filler class including mullite in a content within a range between 1 wt % and not greater than 30 wt % for a total weight of the body.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

Embodiments disclosed herein are related to abrasive articles including a body including a bond material and abrasive articles contained within the bond material. Particularly, the bond material can include a filler composition. In an embodiment, the filler composition can include at least one filler from a first filler class. In another embodiment, the filler composition can include at least one filler from a second filler class. The use of the filler composition of embodiments herein may facilitate improved performance of the bonded abrasive. Without wishing to be tied to a particular theory, it is thought that the filler compositions of the embodiments herein may be suitable to limit excessive volumetric expansion of the bonded abrasive body during operation, thus improving the life and operability of the bonded abrasive.

In an embodiment, the body of the abrasive article can include the filler composition contained within the bond material. The filler composition can include at least one filler from a first filler class including, for instance, pyrite, potassium sulfate (K₂SO₄), potassium chloride (KCl), lime (CaO), and any combination thereof. In another embodiment, the filler composition can include at least one filler from a second filler class including, for example, basalt, mullite, zinc sulfide (ZnS), barium sulfate (BaSO₄), potassium titanate (K₂O.nTiO₂, where n is at least 1 and no greater than 10) or any combination thereof.

In an embodiment, the second filler class can include basalt to facilitate improved heat resistance and/or mechanical properties of the abrasive article. In a further embodiment, the filler composition can include the second filler class including basalt in a content, such as within a range of at least 1 wt % and not greater than 30 wt % for a total weight of the body.

In a further embodiment, the body can include basalt in a content of at least 1%, such as at least 2 wt % or at least 2.2 wt % or at least 2.4 wt % or at least 2.6 wt % or at least 2.8 wt % or at least 3 wt % or at least 3.2 wt % or at least 3.4 wt % or at least 3.6 wt % or at least 3.8 wt % or at least 4 wt % or at least 4.2 wt % or at least 4.4 wt % or at least 4.6 wt %. In another embodiment, the body may include basalt in a content of not be greater than 30 wt % for a total weight of the body, such as not greater than 28 wt % or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6.5 wt %. It will be appreciated that the body can include a content of basalt within a range including any of the minimum and maximum percentages disclosed herein. For instance, the body can include a content of basalt within a range of at least 1 wt % and not greater than 30 wt % for a total weight of the body, such as within a range of 2 wt % to 26 wt %, 2.4 wt % to 22 wt % or within a range of 2.8 wt % to 18 wt % or within a range of 3.2 wt % to 16 wt % or within a range of 3.5 wt % to 10 wt % or within a range of 3.8 wt % to 6.5 wt %.

In a further embodiment, the basalt can have an elongated shape having a length greater than a width. For example, the basalt can have a length of at least 1 mm, such as at least 2 mm or at least 2.5 mm or at least 3 mm or at least 3.5 mm or at least 4 mm or at least 5 mm or at least 6 mm or at least 7 mm or at least 8 mm. In another instance, the length of the basal may be not greater than 12 mm, such as not greater than 11 mm or not greater than 10 mm or not greater than 9.5 mm or not greater than 9 mm or not greater than 8.5 mm or not greater than 8 mm or not greater than 7.5 mm or not greater than 7 mm. It will be appreciated that the basalt can have a length within a range including any of the minimum and maximum values disclosed herein. For instance, the basalt can have a length within a range including at least 1 mm and not greater than 12 mm, such as within a range of 2 mm to 11 mm or within a range of 2.5 mm to 10 mm or within a range of 3 mm to 9 mm. In a particular embodiment, the basalt can have a length in a range of 3 mm to 8 mm.

In a further embodiment, the basalt can have a width of at least 0.01 mm, such as at least 0.02 mm or at least 0.03 mm or at least 0.04 mm or at least 0.05 mm. In another embodiment, the basalt can have a width of not greater than 0.8 mm, such as not greater than 0.7 mm or not greater than 0.65 mm or not greater than 0.6 mm or not greater than 0.55 mm or not greater than 0.5 mm. It will be appreciated that the basalt can have a width within a range including any of the minimum and maximum values disclosed herein. For instance, the basalt can have a width within a range including at least 0.01 mm and not greater than 0.8 mm, such as within a range of 0.03 mm to 0.75 mm or within a range of 0.04 mm to 0.65 mm or within a range of 0.05 mm to 0.6 mm. In a particular embodiment, the basalt can have a width in a range of 0.05 mm to 0.5 mm.

In a further embodiment, the basalt can have an aspect ratio of length:width. For example, the aspect ratio of length:width can be at least 2:1, such as at least 3:1 or at least 4:1 or at least 5:1 or at least 6:1 or at least 7:1 or at least 8:1 or at least 9:1 or at least 10:1 or at least 20:1 or at least 50:1 or at least 100:1. In another instance, the aspect ratio of length:width may not be greater than 300:1, such as not greater than 280:1 or not greater than 260:1 or not greater than 240:1 or not greater than 220:1 or not greater than 200:1 or not greater than 190:1 or not greater than 180:1 or not greater than 160:1. It will be appreciated that the basalt can have an aspect ratio within a range including any of the minimum and maximum values disclosed herein. For instance, the basalt can have an aspect ratio within a range including at least 2:1 to 300:1, such as within a range of 3:1 to 200:1 or within a range of 4:1 to 190:1. In a particular embodiment, the basalt can have an aspect ratio within a range of 2:1 to 160:1.

In an embodiment, the basalt can be in the form of a fibrous material. For example, the basalt can be in the form of bundled fibers, entangled fibers, or both.

In another embodiment, the second filler class can include zinc sulfide (ZnS) to facilitate improved heat resistance and/or mechanical properties of the abrasive article In a further embodiment, the composition can include the second filler class including zinc sulfide (ZnS) in a content, such as within a range between 1 wt % and not greater than 30 wt % for a total weight of the body.

In accordance with another embodiment, the body can include a content of zinc sulfide of at least 1 wt % for a total weight of the body, such as at least 2 wt % or at least 2.2 wt % or at least 2.4 wt % or at least 2.6 wt % or at least 2.8 wt % or at least 3 wt % or at least 3.2 wt % or at least 3.4 wt % or at least 3.6 wt % or at least 3.8 wt % or at least 4 wt % or at least 4.2 wt % or at least 4.4 wt % or at least 4.6 wt % or at least 4.8 wt % or at least 5 wt % or at least 5.2 wt % or at least 5.4 wt % or at least 5.6 wt % or at least 5.8 wt % or at least 6 wt % or at least 6.2 wt % or at least 6.4 wt % or at least 6.6 wt % or at least 6.8 wt % or at least 7 wt % or at least 7.2 wt % or at least 7.4 wt % or at least 7.6 wt % or at least 7.8 wt % or at least 8 wt % or at least 8.2 wt % or at least 8.4 wt %. In still another embodiment, the body may include a content of zinc sulfide of not greater than 30 wt % for a total weight of the body, such as not greater than 28 wt % or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt %. It will be appreciated that the body can include a content of zinc sulfide within a range including any of the minimum and maximum percentages disclosed herein. For instance, the body can include a content of zinc sulfide within a range of 1 wt % to 30 wt % for a total weight of the body, such as within a range of 2 wt % to 28 wt % or 2.8 wt % to 26 wt % or within a range of 3.6 wt % to 24 wt % or within a range of 4.2 wt % to 20 wt % or within a range of 5.4 wt % to 16 wt % or within a range of 6 wt % to 10 wt %.

In a further embodiment, the second filler claims can include barium sulfate (BaSO₄) to facilitate improved heat resistance and/or mechanical properties of the abrasive article. In a further embodiment, the filler composition can include the second filler class including barium sulfate (BaSO₄) in a content, such as within a range of at least 1 wt % and not greater than 30 wt % for a total weight of the body.

In an embodiment, the body can include a content of barium sulfate (BaSO₄) of at least 1 wt % for a total weight of the body, such as at least 2 wt % or at least 2.2 wt % or at least 2.4 wt % or at least 2.6 wt % or at least 2.8 wt % or at least 3 wt % or at least 3.2 wt % or at least 3.4 wt % or at least 3.6 wt % or at least 3.8 wt % or at least 4 wt % or at least 4.2 wt % or at least 4.4 wt % or at least 4.6 wt % or at least 4.8 wt % or at least 5 wt % or at least 5.2 wt % or at least 5.4 wt % or at least 5.6 wt % or at least 5.8 wt % or at least 6 wt % or at least 6.2 wt %. In another embodiment, the body may include a content of barium sulfate (BaSO₄) of not greater than 30 wt % for a total weight of the body, such as not greater than 28 wt % or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6.5 wt %. It will be appreciated that the body can include a content of barium sulfate within a range including any of the minimum and maximum percentages disclosed herein. For instance, the body can include a content of barium sulfate in a range of 1 wt % to 30 wt % for a total weight of the body, such as within a range of 2 wt % to 26 wt % or within a range of 2.6 wt % to 22 wt % or within a range of 3.2 wt % to 18 wt % or within a range of 3.8 wt % to 14 wt % or within a range of 4 wt % to 12 wt % or within a range of 4.2 wt % to 10 wt %.

In a further embodiment, the barium sulfate can have an average particle size of at least 20 μm, such as at least 25 μm or at least 30 μm or at least 35 μm or at least 40 μm or at least 45 μm. In another embodiment, the barium sulfate can have an average particle size of not greater 80 μm, such as not greater than 75 μm or not greater than 70 μm or not greater than 65 μm or not greater than 60 μm or not greater than 55 μm or not greater than 50 μm or not greater than 45 μm. It will be appreciated that the barium sulfate can have an average particle size within a range including any of the minimum and maximum values disclosed herein. For instance, the barium sulfate can have an average particle size in a range of 20 μm to 75 μm, such as within a range of 30 μm to 70 μm or within a range of 35 μm to 60 μm or within a range of 40 μm to 55 μm. In a particular embodiment, the basalt can have an average particle size within a range of 40 μm to 50 μm.

In an embodiment, the barium sulfate can be made from a natural mineral, such as barite, chemically synthesized, or both.

In an embodiment, the second filler class can include potassium titanate (K₂O.nTiO₂) to facilitate improved heat resistance and/or mechanical properties of the abrasive article. In another embodiment, the filler composition can include the second filler class that can include potassium titanate (K₂O.nTiO₂) in a content, such as within a range between 0.1 wt % and not greater than 30 wt % for a total weight of the body.

In another instance, the body can include a content of potassium titanate (K₂O.nTiO₂) of at least 0.1 wt % for a total weight of the body, such as at least 0.2 wt % or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.1 wt % or at least 1.2 wt % or at least 1.3 wt % or at least 1.4 wt % or at least 1.5 wt %. Still in another embodiment, the content of potassium titanate (K₂O.nTiO₂) of the body may not be greater than 30 wt % for a total weight of the body, such as not greater than 28 wt % or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2.8 wt % or not greater than 2.6 wt % or not greater than 2.4 wt % or not greater than 2.2 wt % or not greater than 2 wt % or not greater than 1.9 wt % or not greater than 1.8 wt % or not greater than 1.7 wt % or not greater than 1.6 wt %. It will be appreciated that the body can include a content of potassium titanate within a range including any of the minimum and maximum percentages disclosed herein. For instance, the body can include a content of potassium titanate within a range of 0.1 wt % to 30 wt % for a total weight of the body, such as within a range of 0.2 wt % to 26 wt % or within a range of 0.4 wt % to 22 wt % or within a range of 0.6 wt % to 18 wt % or within a range of 0.7 wt % to 14 wt % or within a range of 0.8 wt % to 14 wt % or within a range of 1 wt % to 8 wt % or within a range of 1.1 wt % to 2.8 wt %.

In a further embodiment, the potassium titanate (K₂O.nTiO₂) can be in the form of a fibrous material. For instance, the potassium titanate (K₂O.nTiO₂) can be in the form of bundled fibers, entangled fibers, or both. In another embodiment, the potassium titanate (K₂O.nTiO₂) can be in the form of a particulate having a particle size of at least 0.1 μm, such as at least 0.2 μm or at least 0.3 μm or at least 0.4 μm or at least 0.5 μm or at least 0.6 μm or at least 0.8 μm or at least of 0.9 μm or at least of 1 μm. In another embodiment, the potassium titanate (K₂O.nTiO₂) can have an average particle size of not greater than 80 μm, such as not greater than 75 μm or not greater than 70 μm or not greater than 65 μm or not greater than 60 μm or not greater than 55 μm. It will be appreciated that the potassium titanate (K₂O.nTiO₂) can have an average particle size within a range including any of the minimum and maximum values disclosed herein. For instance, potassium titanate (K₂O.nTiO₂) can have an average particle size in a range of 0.1 μm to 80 μm, such as within a range of 0.3 μm to 70 μm or within a range of 0.4 μm to 65 μm or within a range of 0.5 μm to 60 μm or within a range of 0.6 μm to 55 μm. In a particular embodiment, the potassium titanate (K₂O.nTiO₂) can have an average particle size within a range of 0.6 μm to 55 μm.

In an embodiment, the second filler class can include mullite to facilitate improved heat resistance and/or mechanical properties of the abrasive article. In accordance with another embodiment, the filler composition can include the second filler class that can include mullite in a content, such as within a range of at least 0.1 wt % and not greater than 30 wt % for a total weight of the body.

In another embodiment, the body can include a content of mullite of at least 0.1 wt % for a total weight of the body, such as at least 0.2 wt % or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or at least 2 wt %. In still another embodiment, the body may include a content of mullite of not greater than 30 wt % for a total weight of the body, such as not greater than 28 wt % or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2.8 wt % or not greater than 2.6 wt % or not greater than 2.4 wt %. It will be appreciated that the body can include a content of mullite within a range including any of the minimum and maximum percentages disclosed herein. For instance, the body can include a content of mullite within a range of 0.1 wt % to 30 wt % for a total weight of the body, such as within a range of 0.2 wt % to 25 wt % or within a range of 0.4 wt % to 20 wt % or within a range of 0.5 wt % to 16 wt % or within a range of 0.8 wt % to 10 wt % or within a range of 1 wt % to 8 wt % or within a range of 1.2 wt % to 6 wt % or within a range of 1.3 wt % to 4 wt %.

In a further embodiment, the mullite can be in the form of a fibrous material. For example, the mullite can be in the form of bundled fibers, entangled fibers, or both. In accordance with another embodiment, mullite can include alumina, silica, or any combination thereof. In a particular embodiment, mullite can consist essentially of alumina and silica. In another particular embodiment, mullite can consist essentially of 3Al₂O₃.SiO₂. In a further embodiment, mullite can have a density of up to 3.16 g/cm³.

In an embodiment, the bond material can include a filler material in addition to the filler composition of embodiments herein. The filler material can include an organic material, an inorganic material, or any combination thereof. Exemplary filler material can include a metal, a ceramic material, a vitreous material, a polymer, or any combination thereof. Particularly, the filler material can be needle-shaped, flakes, granular, fiber, or any combination thereof. More particularly, the filler material can have a coefficient of thermal expansion greater than 0 and not greater than 2×10⁻⁵/° C. (between 10° C. to 200° C.). In a non-limiting embodiment, the filler material can include chopped strand fibers, glass fibers, mineral wool, a metal fiber, a ceramic fiber, a carbon fiber, a aramid fiber, wollastonite, Frit, Talc, mica, montmorillonite, nature clay, or the like. In some embodiments, the filler material can include a coating that can include an organic material or an inorganic material. For example, a glass fiber can be coated with a polymer, such as phenolic resin. In another instance, a glass fiber can be coated with silane.

In an embodiment, the body can include the first filler class in a content that may facilitate improved heat resistance and/or mechanical properties of the abrasive article. For example, the body can include at least 1 wt % of the first filler class for a total weight of the body, such as at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt %. In another non-limiting embodiment, the body may include not greater than 50 wt % of the first filler class for a total weight of the body. For example, the body may include not greater than 49 wt % of the first filler class for a total weight of the body, such as not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt %. It will be appreciated that the body can include the first filler class in a content within a range including any of the minimum and maximum percentages disclosed herein. For example, the body can include the first filler class in a content within a range including at least 1 wt % and not greater than 50 wt % for a total weight of the body, such as within a range of 2 wt % to 48 wt % or within a range of 5 wt % to 42 wt % or within a range of 7 wt % to 40 wt % or within a range of 11 wt % to 38 wt %.

In an embodiment, the body can include at least 1 wt % of the second filler class for a total weight of the body to facilitate improved heat resistance and/or mechanical properties of the abrasive article. For example, the body can include at least 2 wt % of the second filler class for a total weight of the body, such as at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt %. In another non-limiting embodiment, the body may include not greater than 50 wt % of the second filler class for a total weight of the body, such as not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt %. It will be appreciated that the body can include the second filler class in a content within a range including any of the minimum and maximum percentages disclosed herein. For example, the body can include the second filler class in a content within a range including at least 1 wt % and not greater than 50 wt % for a total weight of the body, such as within a range of 2 wt % to 49 wt % or within a range of 4 wt % to 44 wt % or within a range of 5 wt % to 42 wt % or within a range of 6 wt % to 38 wt %.

In a non-limiting embodiment, the body can include a ratio (F1/F2) of at least 0.1, wherein F1 represents the weight percent of the first filler class for the total weight of the body and F2 represents the weight percent of the second filler class of the total weight of the body. For example, the ratio (F1/F2) can be at least 0.2 or at least 0.3 or at least 0.4 or at least 0.5 or at least 0.6 or at least 0.7 or at least 0.8 or at least 0.9 or at least 1 or at least 1.1 or at least 1.5 or at least 2 or at least 3 or at least 5 or at least 8 or at least 10 or at least 12 or at least 15 or at least 18 or at least 20 or at least 22 or at least 25 or at least 28 or at least 30. In another non-limiting embodiment, the ratio (F1/F2) may be not greater than 100, such as not greater than 90 or not greater than 80 or not greater than 70 or not greater than 60 or not greater than 50 or not greater than 40 or not greater than 30 or not greater than 28 or not greater than 25 or not greater than 22 or not greater than 20 or not greater than 18 or not greater than 15 or not greater than 12 or not greater than 10 or not greater than 8 or not greater than 6 or not greater than 5 or not greater than 4 or not greater than 3 or not greater than 2 or not greater than 1.5 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1. It will be appreciated that the ratio (F1/F2) can be within a range including any of the minimum and maximum values disclosed herein. For example, the ratio (F1/F2) can be within a range including at least 0.1 and not greater than 100, such as within a range of 0.5 to 90 or within a range of 0.9 to 70 or within a range of 2 to 50 or within a range of 5 to 22.

In an embodiment, the first filler class can include any of pyrite, potassium sulfate (K₂SO₄), potassium chloride (KCl), lime (CaO), and any combination thereof in weight percent for a total weight of the body. In another embodiment, the first filler class can include a combination of pyrite, potassium sulfate (K₂SO₄), potassium chloride (KCl), and lime (CaO) as measured in weight percent for a total weight of the body. In still another embodiment, the first filler class can include a combination of pyrite and potassium sulfate (K₂SO₄), where the first filler class can include a greater content of pyrite (Cpy) as measured in weight percent for a total weight of the body as compared to a content of potassium sulfate (Cps). For example, the body can include a ratio (Cpy/Cps) of at least 1, such as at least 1.1 or at least 1.2 or at least 1.3 or at least 1.4 or at least 1.5 or at least 1.6 or at least 1.7 or at least 1.8 or at least 1.9 or at least 2 or at least 2.1 or at least 2.2. In another non-limiting instance, the body may include a ratio (Cpy/Cps) of not greater than 10, such as not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.9 or not greater than 2.8 or not greater than 2.7 or not greater than 2.6 or not greater than 2.5. It will be appreciated that the ratio (Cpy/Cps) can be within a range including any of the minimum and maximum values disclosed herein. For example, the ration (Cpy/Cps) can be within a range including at least 1 and not greater than 10, such as within a range of 1.1 to 9.5 or within a range of 1.3 to 8.5 or within a range of 1.5 to 7 or within a range of 1.7 to 5.5.

In an embodiment, the body can include a content of pyrite that may facilitate improved heat resistance and/or mechanical properties. For example, the body can include a content of pyrite of at least 2 wt % for a total weight of the body, such as at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt %. In another non-limiting embodiment, the body may include a content of pyrite of not greater than 49 wt % for a total weight of the body, such as not greater than 48 wt % or not greater than 47 wt % or not greater than 46 wt % or not greater than 45 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt % or not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 35 wt % or not greater than 34 wt % or not greater than 33 wt % or not greater than 32 wt % or not greater than 31 wt % or not greater than 30 wt %. It will be appreciated that the body can include a content of pyrite within a range including any of the minimum and maximum percentages of embodiment herein. For instance, the body can include a content of pyrite within a range including at least 2 wt % and not greater than 49 wt % for a total weight of the body, such as within a range of 4 wt % to 45 wt % or within a range of 6 wt % to 40 wt % or within a range of 10 wt % to 37 wt % or within a range of 14 wt % to 31 wt %.

In another instance, the first filler class can include a combination of potassium sulfate (K₂SO₄) and potassium chloride (KCl). In an application, the first filler class can include a greater content of potassium sulfate (K₂SO₄) as measured in weight percent for a total weight of the body as compared to a content of potassium chloride (KCl) as measured in weight percent for a total weight of the body. In another application, the first filler class can include a lesser content of potassium sulfate (K₂SO₄) as measured in weight percent for a total weight of the body as compared to a content of potassium chloride (KCl) as measured in weight percent for a total weight of the body.

In accordance with an embodiment, the body can include a total content of potassium sulfate (K₂SO₄) and potassium chloride (KCl) that may facilitate improved heat resistance and/or mechanical properties of the body. For example, the total content of potassium sulfate (K₂SO₄) and potassium chloride (KCl) can be at least 1 wt % for a total weight of the body, such as at least 2 wt % or at least 3 wt % or at least 4 wt % or at least 5 wt % or at least 6 wt % or at least 7 wt % or at least 8 wt %. In accordance with another non-limiting embodiment, the body may include a total content of potassium sulfate (K₂SO₄) and potassium chloride (KCl) of not greater than 30 wt % for a total weight of the body, such as or not greater than 25 wt % or not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt %. It will be appreciated that the total content of potassium sulfate (K₂SO₄) and potassium chloride (KCl) can be within a range including any of the minimum and maximum percentages disclosed herein. For instance, the total content can be within a range including at least 1 wt % and not greater than 30 wt % for a total weight of the body, such as within a range of 3 wt % to 25 wt % or within a range of 5 wt % to 20 wt % or within a range of 6 wt % to 17 wt %.

In an embodiment, the first filler class can include a combination of potassium sulfate (K₂SO₄) and potassium chloride (KCl), where the first filler class can include a ratio (Cps/Cpc) that may facilitate improved thermal expansion and/or mechanical properties, where Cps represents the content of potassium sulfate in weight percent for a total weight of the body and Cpc in represents the content of potassium chloride in weight percent for a total weight of the body. For example, the ratio (Cps/Cpc) can be at least 0.1, such as at least 0.2 or at least 0.3 or at least 0.4 or at least 0.5 or at least 0.6 or at least 0.7 or at least 0.8 or at least 0.9 or at least 1 or at least 1.1 or at least 1.2 or at least 1.3 or at least 1.4 or at least 1.5 or at least 1.6 or at least 1.7 or at least 1.8 or at least 1.9 or at least 2 or at least 2.2 or at least 2.5. In another non-limiting embodiment, the ratio (Cps/Cpc) may be not greater than 10, such as not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.9 or not greater than 2.8 or not greater than 2.7 or not greater than 2.6 or not greater than 2.5 or not greater than 2 or not greater than 1.5 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1. It will be appreciated the ratio (Cps/Cpc) can be within a range including any of the minimum and maximum values disclosed herein. For example, the ratio (Cps/Cpc) can be within a range including at least 0.1 and not greater than 10, such as within a range of 0.2 to 8 or within a range 0.4 to 6 or within a range of 0.8 to 4 or with a range of 1 to 2.5. In a particular embodiment, the ratio (Cps/Cpc) is within a range including at least 1 and not greater than 2.

In an embodiment, the first filler class can include pyrite and a blend of potassium sulfate (K₂SO₄) and potassium chloride (KCl). For example, the first filler class can include a greater content of pyrite as measured in weight percent for a total weight of the body as compared to a content of the blend including potassium sulfate (K₂SO₄) and potassium chloride (KCl) as measured in weight percent for a total weight of the body. In another instance, the body can include a total content of pyrite, potassium sulfate (K₂SO₄), and potassium chloride (KCl). For example, the total content of pyrite, potassium sulfate (K₂SO₄), and potassium chloride (KCl) can be of at least 1 wt % for a total weight of the body, such as or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt %. In another instance, the total content of pyrite, potassium sulfate (K₂SO₄), and potassium chloride (KCl) may be not greater than 50 wt % for a total weight of the body, such as not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt %. It will be appreciated that the total content of pyrite, potassium sulfate (K₂SO₄), and potassium chloride (KCl) can be within a range including any of the minimum and maximum percentages disclosed herein. For example, the total content can be within a range of 1 wt % to 50 wt % for a total weight of the body, such as within a range of 3 wt % to 47 wt % or within a range of 5 wt % to 42 wt % or within a range of 8 wt % to 38 wt % or within a range of 12 wt % to 36 wt %.

In a further embodiment, the first filler class can include a combination of pyrite and a blend of potassium sulfate (K₂SO₄) and potassium chloride (KCl) and can include a ratio (Cpy/Cb), where Cpy represents the content of pyrite in weight percent for a total weight of the body and Cb in represents the content of the blend of potassium sulfate and potassium chloride in weight percent for a total weight of the body. The ratio (Cpy/Cb) can be at least 0.1, such as the ratio (Cpy/Cb) can be at least 0.2 or at least 0.3 or at least 0.4 or at least 0.5 or at least 0.6 or at least 0.7 or at least 0.8 or at least 0.9 or at least 1 or at least 1.1 or at least 1.2 or at least 1.3 or at least 1.4 or at least 1.5 or at least 1.6 or at least 1.7 or at least 1.8 or at least 1.9 or at least 2 or at least 2.2 or at least 2.5. In another non-limiting embodiment, the ratio (Cpy/Cb) may be not greater than 10, such as not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.9 or not greater than 2.8 or not greater than 2.7 or not greater than 2.6 or not greater than 2.5 or not greater than 2 or not greater than 1.5 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1. It will be appreciated the ratio (Cpy/Cb) can be within a range including any of the minimum and maximum values disclosed herein. For instance, the ratio (Cpy/Cb) can be within a range including at least 0.1 and not greater than 10, such as within a range of 0.4 to 8.5 or within a range of 0.8 to 7 or within a range of 1 to 6 or within a range of 1.4 to 5.

In an embodiment, the body can include a content of lime (CaO) that may facilitate improved heat resistance and/or mechanical properties of the abrasive article. For example, the content of lime (CaO) can be at least 0.1 wt % for a total weight of the body, such as at least or at least 0.2 wt % or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.1 wt % or at least 1.2 wt %. In another non-limiting embodiment, the body may include a content of lime (CaO) of not greater than 10 wt % for a total weight of the body, such as not greater than 9 wt % or not greater than 8 wt % or not greater than 7 wt % or not greater than 6 wt % or not greater than 5 wt % or not greater than 4.5 wt % or not greater than 4 wt % or not greater than 3.5 wt % or not greater than 3 wt % or not greater than 2.5 wt % or not greater than 2 wt % or not greater than 1.9 wt % or not greater than 1.8 wt % or not greater than 1.7 wt %. It will be appreciated that the content of lime (CaO) can be within a range including any of the maximum and minimum percentages disclosed herein. For instance, the content of lime (CaO) can be within a range including at least 0.1 wt % and not greater than 10 wt % for a total weight of the body, such as within a range of 0.4 wt % to 8 wt % or within a range of 0.7 wt % to 6 wt % or within a range of 0.9 wt % to 5 wt %.

In another embodiment, the first filler class includes a combination of pyrite, potassium sulfate (K₂SO₄), potassium chloride (KCl), and lime (CaO) as measured in weight percent for a total weight of the body. In an application, the first filler class can include a greater content of pyrite (Cpy) as measured in weight percent for a total weight of the body as compared to a content of lime (Ccc) as measured in weight percent for a total weight of the body to facilitate improved thermal expansion and/or mechanical properties of the abrasive article. For instance, the body can include a ratio (Cpy/Ccc) of at least 1, such as at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7 or at least 8 or at least 9 or at least 10 or at least 11 or at least 12 or at least 13 or at least 14. In another instance, the body may include a ratio (Cpy/Ccc) of not greater than 100, wherein the ratio (Cpy/Ccc) is not greater than 95 or not greater than 90 or not greater than 85 or not greater than 80 or not greater than 75 or not greater than 70 or not greater than 65 or not greater than 60 or not greater than 55 or not greater than 50 or not greater than 45 or not greater than 40 or not greater than 35 or not greater than 30 or not greater than 25 or not greater than 22 or not greater than 20 or not greater than 18 or not greater than 16. It will be appreciated that the ratio (Cpy/Ccc) can be within a range including any of the minimum and maximum values disclosed herein. For example, the ratio (Cpy/Ccc) can be within a range of 1 to 100, such as within a range of 1.5 to 90 or within a range of 2 to 75 or within a range of 4 to 60 or within a range of 8 to 50 or within a range of 30 to 25.

In another embodiment, the first filler class can include a greater content of potassium sulfate (Cps) as measured in weight percent for a total weight of the body as compared to a content of lime (Ccc) as measured in weight percent for a total weight of the body to facilitate improved thermal expansion and/or mechanical properties of the abrasive article. For instance, the body can include a ratio (Cps/Ccc) of at least 1, such as at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7. In another instance, the ratio (Cps/Ccc) may not be greater than 20, such as not greater than 18 or not greater than 16 or not greater than 14 or not greater than 12 or not greater than 10 or not greater than 9 or not greater than 8 or not greater than 7 or not greater than 6 or not greater than 5. It will be appreciated that the ratio (Cps/Ccc) can be within a range including any of the minimum and maximum values disclosed herein. For example, the ratio (Cps/Ccc) can be within a range of 1 to 20, such as within a range of 1.5 to 18 or within a range of 1.8 to 15 or within a range of 2 to 12 or within a range of 4 to 10.

In yet another application, the first filler class can include a greater content of potassium chloride (Cpc) as measured in weight percent for a total weight of the body as compared to a content of lime (Ccc) as measured in weight percent for a total weight of the body to facilitate improved thermal expansion and/or mechanical properties of the abrasive article. For example, the body can include a ratio (Cpc/Ccc) of at least 1, such as wherein the ratio (Cpc/Ccc) is at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7. For another example, the ratio (Cpc/Ccc) can be not greater than 18 or not greater than 16 or not greater than 14 or not greater than 12 or not greater than 10 or not greater than 9 or not greater than 8 or not greater than 7 or not greater than 6 or not greater than 5. It will be appreciated that the ratio (Cpc/Ccc) can be within a range including any of the minimum and maximum values disclosed herein. For instance, the ratio (Cpc/Ccc) can be within a range of 1 to 18, such as within a range of 1.4 to 18 or within a range of 1.7 to 16 or within a range of 1.9 to 14 or within a range of 3 to 12 or within a range to 5 to 10.

In still another application, the first filler class can include a greater content of a blend of potassium sulfate and potassium chloride (Cb) as measured in weight percent for a total weight of the body as compared to a content of lime (Ccc) as measured in weight percent for a total weight of the body to facilitate improved thermal expansion and/or mechanical properties of the abrasive article. For example, the ratio (Cb/Ccc) can be at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7. In another instance, the ratio (Cb/Ccc) may not be greater than 18 or not greater than 16 or not greater than 14 or not greater than 12 or not greater than 10 or not greater than 9 or not greater than 8 or not greater than 7 or not greater than 6 or not greater than 5. It will be appreciated that the ratio (Cb/Ccc) can be within a range including any of the minimum and maximum values disclosed herein. For example, the ratio (Cb/Ccc) can be within a range of 1.1 to 18, such as within a range of 1.3 to 16 or within a range of 1.6 to 14 or within a range of 2 to 10.

In a non-limiting embodiment, the abrasive particles can include a material selected from the group of oxides, nitrides, carbides, borides silicides, silicates, superabrasives, minerals, monocrystalline, polycrystalline, amorphous, or a combination thereof. In a particular embodiment, the abrasive particles can include alumina. More particularly, the abrasive particles can consist essentially of alumina.

In accordance with an embodiment, the body can include at least 5 wt % and not greater than 90 wt % abrasive particles for the total weight of the body. For example, the body can include 15 wt % to 85 wt % abrasive particles or 25 wt % to 80 wt % abrasive particles or 35 wt % to 75 wt % abrasive particles or 40 wt % to 70 wt % abrasive particles. In a particular embodiment, the body can include 50 wt % to 65 wt % abrasive particles for a total weight of the body.

In another embodiment, the abrasive article can have a maximum linear thermal expansion and a maximum linear thermal expansion ratio, when exposed to a range of temperature starting from a room temperature (as used herein, referring to a temperature within 20° C. to 25° C.) and increased continuously to 550° C. To facilitate the measurement of the maximum linear thermal expansion, the abrasive article can be placed in the furnace enclosure of a thermal expansion analyzer (e.g. the TMA 4000 thermomechanical analyzer (PerkinElmer)), and linear thermal expansion of the abrasive article can be measured in a dynamic manner in accordance with ASTM DE831-03, when the temperature inside the furnace enclosure is increased continuously from the room temperature to 550° C. The maximum linear thermal expansion is the biggest linear thermal expansion among all of the linear thermal expansions that take place during the continuous temperature increase from the room temperature to 550° C. The maximum linear thermal expansion ratio (l_{mσ}) is calculated based on the equation l_{mσ}=(lₘ−l₀)/l₀×100%, where a linear size of the abrasive article (e.g. a length or a diameter of the body) at the room temperature is the baseline (l₀), and the linear size of the abrasive article at the temperature of the maximum thermal expansion is lₘ.

In accordance with an embodiment, the abrasive article can have a maximum linear thermal expansion ratio of not greater than 2%, such as not greater than 1.8% or not greater than 1.6% or not greater than 1.4% or not greater than 1.2% or not greater than 1% or not greater than 0.8% or not greater than 0.7% or not greater than 0.65% or not greater than 0.6% or not greater than 0.55% or not greater than 0.5% or not greater than 0.45%. In another embodiment, the abrasive article may have a maximum linear thermal expansion ratio greater than 0, such as at least 0.0001% or at least 0.0005% or at least 0.0007% or at least 0.0009% or at least 0.001% or at least 0.003% or at least 0.005% or at least 0.007% or at least 0.009% or at least 0.01%. It will be appreciated that the maximum linear thermal expansion ratio can be within a range including any of the minimum and maximum percentages disclosed herein. For example, the abrasive article can have a maximum linear thermal expansion ratio within a range from greater than 0 to 2%, such as within a range of 0.0001% to 1.2% or within a range of 0.0003% to 0.7% or within a range of 0.0005% to 0.65% or within a range of 0.0007% to 0.6% or within a range of 0.0009% to 0.55% or at least 0.001% to 0.5%. In a particular embodiment, the abrasive article can have a maximum linear thermal expansion ratio within a range from greater than 0 to 0.7%.

In accordance with an embodiment, the bond material can include a polymer, such as a thermoset or a thermoplastic. In accordance with another embodiment, the bond material can include a resin, such as phenolic resins, epoxy resins, polyester resins, polyurethanes, polyester, rubber, polyimide, polybenzimidazole, aromatic polyamide, modified phenolic resins (such as: epoxy modified and rubber modified resins, or phenolic resin blended with plasticizers, etc.), and so forth, as well as any combination thereof. In a particular embodiment, the bond material can include a phenolic resin. Exemplary phenolic resins can include resole and novolac.

In accordance with an embodiment, the body can include at least 1 wt % and not greater than 70 wt % bond material for the total weight of the body. For example, the body can include at least 5 wt % to 60 wt % bond material or at least 10 wt % to 55 wt % bond material or at least 15 wt % to 50 wt % bond material for a total weigh of the body.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Item 1. An abrasive article comprising:

a body including:
a bond material;
abrasive particles contained within the bond material; and
a filler composition contained within the bond material, wherein the filler composition includes at least one filler from a first filler class and at least one filler from a second filler class, wherein:
   the first filler class includes pyrite, potassium sulfate (K₂SO₄), potassium chloride (KCl), and lime (CaO), and
   the second filler class includes basalt, mullite, zinc sulfide (ZnS), barium sulfate (BaSO₄), potassium titanate K₂O.nTiO₂ n=1-10) or a combination thereof.

Item 2. An abrasive article comprising:

a body including:
a bond material;
abrasive particles contained within the bond material; and
a filler composition contained within the bond material, wherein the filler composition comprises:
   at least one filler from a first filler class including pyrite, potassium sulfate (K₂SO₄), potassium chloride (KCl), lime (CaO), or a combination thereof, and
   a second filler class including basalt in a content within a range between 1 wt % and not greater than 30 wt % for a total weight of the body.

Item 3. An abrasive article comprising:

a body including:
a bond material;
abrasive particles contained within the bond material; and
a filler composition contained within the bond material, wherein the filler composition comprises:
   at least one filler from a first filler class including pyrite, potassium sulfate (K₂SO₄), potassium chloride (KCl), lime (CaO), or a combination thereof, and
   a second filler class including zinc sulfide (ZnS) in a content within a range between 1 wt % and not greater than 30 wt % for a total weight of the body.

Item 4. An abrasive article comprising:

a body including:
a bond material;
abrasive particles contained within the bond material; and
a filler composition contained within the bond material, wherein the filler composition comprises:
   at least one filler from a first filler class including pyrite, potassium sulfate (K₂SO₄), potassium chloride (KCl), lime (CaO), or a combination thereof, and
   a second filler class including barium sulfate (BaSO₄) in a content within a range between 1 wt % and not greater than 30 wt % for a total weight of the body.

Item 5. An abrasive article comprising:

a body including:
a bond material;
abrasive particles contained within the bond material; and
a filler composition contained within the bond material, wherein the filler composition comprises:
   at least one filler from a first filler class including pyrite, potassium sulfate (K₂SO₄), potassium chloride (KCl), calcium carbonate (CaCO₃), or a combination thereof, and
   a second filler class including potassium titanate (K₂O.nTiO₂ n=1-10) in a content within a range between 0.1 wt % and not greater than 30 wt % for a total weight of the body.

Item 6. An abrasive article comprising:

a body including:
a bond material;
abrasive particles contained within the bond material; and
a filler composition contained within the bond material, wherein the filler composition comprises:
   at least one filler from a first filler class including pyrite, potassium sulfate (K₂SO₄), potassium chloride (KCl), calcium carbonate (CaCO₃), or a combination thereof, and
   a second filler class including mullite in a content within a range between 1 wt % and not greater than 30 wt % for a total weight of the body.

Item 7. The abrasive article of any one of items 1, 2, 3, 4, 5, and 6, wherein the body comprises at least 1 wt % of the first filler class for a total weight of the body or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt %.

Item 8. The abrasive article of any one of items 1, 2, 3, 4, 5, and 6, wherein the body comprises not greater than 50 wt % of the first filler class for a total weight of the body or not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt %.

Item 9. The abrasive article of any one of items 1, 2, 3, 4, 5, and 6, wherein the body comprises at least 1 wt % of the second filler class for a total weight of the body or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt %.

Item 10. The abrasive article of any one of items 1, 2, 3, 4, 5, and 6, wherein the body comprises not greater than 50 wt % of the second filler class for a total weight of the body or not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt %.

Item 11. The abrasive article of any one of items 1, 2, 3, 4, 5, and 6, wherein the body includes a ratio (F1/F2) of at least 0.1, wherein F1 represents the weight percent of the first filler class for the total weight of the body and F2 represents the weight percent of the second filler class of the total weight of the body, wherein the ratio (F1/F2) is at least 0.2 or at least 0.3 or at least 0.4 or at least 0.5 or at least 0.6 or at least 0.7 or at least 0.8 or at least 0.9 or at least 1 or at least 1.1 or at least 1.5 or at least 2 or at least 3 or at least 5 or at least 8 or at least 10 or at least 12 or at least 15 or at least 18 or at least 20 or at least 22 or at least 25 or at least 28 or at least 30.

Item 12. The abrasive article of any one of items 1, 2, 3, 4, 5, and 6, wherein the body includes a ratio (F1/F2) of not greater than 100, wherein F1 represents the weight percent of the first filler class for the total weight of the body and F2 represents the weight percent of the second filler class of the total weight of the body, wherein the ratio (F1/F2) is not greater than 90 or not greater than 80 or not greater than 70 or not greater than 60 or not greater than 50 or not greater than 40 or not greater than 30 or not greater than 28 or not greater than 25 or not greater than 22 or not greater than 20 or not greater than 18 or not greater than 15 or not greater than 12 or not greater than 10 or not greater than 8 or not greater than 6 or not greater than 5 or not greater than 4 or not greater than 3 or not greater than 2 or not greater than 1.5 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1.

Item 13. The abrasive article of any one of items 1, 2, 3, 4, 5, and 6, wherein the first filler class includes a combination of pyrite, potassium sulfate (K₂SO₄), potassium chloride (KCl), and calcium carbonate (CaCO₃) as measured in weight percent for a total weight of the body.

Item 14. The abrasive article of any one of items 1, 2, 3, 4, 5, and 6, wherein the first filler class includes a combination of pyrite and potassium sulfate (K₂SO₄) and wherein the first filler class includes a greater content of pyrite (Cpy) as measured in weight percent for a total weight of the body as compared to a content of potassium sulfate (Cps).

Item 15. The abrasive article of item 14, wherein the body includes a ratio (Cpy/Cps) of at least 1, wherein the ratio (Cpy/Cps) is at least 1.1 or at least 1.2 or at least 1.3 or at least 1.4 or at least 1.5 or at least 1.6 or at least 1.7 or at least 1.8 or at least 1.9 or at least 2 or at least 2.1 or at least 2.2.

Item 16. The abrasive article of item 14, wherein the body includes a ratio (Cpy/Cps) of not greater than 10, wherein the ratio (Cpy/Cps) is not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.9 or not greater than 2.8 or not greater than 2.7 or not greater than 2.6 or not greater than 2.5.

Item 17. The abrasive article of any one of items 1, 2, 3, 4, 5, and 6, wherein the body comprises a content of pyrite of at least 2 wt % for a total weight of the body or at least or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt %.

Item 18. The abrasive article of any one of items 1, 2, 3, 4, 5, and 6, wherein the body comprises a content of pyrite of not greater than 40 wt % for a total weight of the body or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt % or not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 35 wt % or not greater than 34 wt % or not greater than 33 wt % or not greater than 32 wt % or not greater than 31 wt % or not greater than 30 wt %. or not greater than 49 wt % or not greater than 48 wt % or not greater than 47 wt % or not greater than 46 wt % or not greater than 45 wt %.

Item 19. The abrasive article of any one of items 1, 2, 3, 4, 5, and 6, wherein the first filler class includes a combination of potassium sulfate (K₂SO₄) and potassium chloride (KCl).

Item 20. The abrasive article of item 19, wherein the first filler class includes a greater content of potassium sulfate (K₂SO₄) as measured in weight percent for a total weight of the body as compared to a content of potassium chloride (KCl) as measured in weight percent for a total weight of the body.

Item 21. The abrasive article of item 19, wherein the first filler class includes a lesser content of potassium sulfate (K₂SO₄) as measured in weight percent for a total weight of the body as compared to a content of potassium chloride (KCl) as measured in weight percent for a total weight of the body.

Item 22. The abrasive article of item 19, wherein the body includes a total content of potassium sulfate (K₂SO₄) and potassium chloride (KCl) of at least 1 wt % for a total weight of the body or at least or at least 2 wt % or at least 3 wt % or at least 4 wt % or at least 5 wt % or at least 6 wt % or at least 7 wt % or at least 8 wt %.

Item 23. The abrasive article of item 19, wherein the body includes a total content of potassium sulfate (K₂SO₄) and potassium chloride (KCl) of not greater than 30 wt % for a total weight of the body or not greater than 25 wt % or not greater than 20 wt % or not greater than 19 wt % or not greater than 18 wt % or not greater than 17 wt % or not greater than 16 wt % or not greater than 15 wt % or not greater than 14 wt % or not greater than 13 wt % or not greater than 12 wt % or not greater than 11 wt % or not greater than 10 wt % or not greater than 9 wt % or not greater than 8 wt % or not greater than 7 wt %.

Item 24. The abrasive article of any one of items 1, 2, 3, 4, 5, and 6, wherein the first filler class includes a combination of potassium sulfate (K₂SO₄) and potassium chloride (KCl), and wherein the first filler class includes a ratio (Cps/Cpc) of at least 0.1, wherein Cps represents the content of potassium sulfate in weight percent for a total weight of the body and Cpc in represents the content of potassium chloride in weight percent for a total weight of the body, wherein the ratio (Cps/Cpc) is at least 0.2 or at least 0.3 or at least 0.4 or at least 0.5 or at least 0.6 or at least 0.7 or at least 0.8 or at least 0.9 or at least 1 or at least 1.1 or at least 1.2 or at least 1.3 or at least 1.4 or at least 1.5 or at least 1.6 or at least 1.7 or at least 1.8 or at least 1.9 or at least 2 or at least 2.2 or at least 2.5.

Item 25. The abrasive article of any one of items 1, 2, 3, 4, 5, and 6, wherein the first filler class includes a combination of potassium sulfate (K₂SO₄) and potassium chloride (KCl), and wherein the first filler class includes a ratio (Cps/Cpc) of not greater than 10, wherein Cps represents the content of potassium sulfate in weight percent for a total weight of the body and Cpc in represents the content of potassium chloride in weight percent for a total weight of the body, wherein the ratio (Cps/Cpc) is not greater than 10, wherein the ratio (Cps/Cpc) is not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.9 or not greater than 2.8 or not greater than 2.7 or not greater than 2.6 or not greater than 2.5 or not greater than 2 or not greater than 1.5 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1.

Item 26. The abrasive article of any one of items 1, 2, 3, 4, 5, and 6, wherein the first filler class includes pyrite and a blend of potassium sulfate (K₂SO₄) and potassium chloride (KCl).

Item 27. The abrasive article of item 26, wherein the first filler class includes a greater content of pyrite as measured in weight percent for a total weight of the body as compared to a content of the blend including potassium sulfate (K₂SO₄) and potassium chloride (KCl) as measured in weight percent for a total weight of the body.

Item 28. The abrasive article of item 26, wherein the body includes a total content of pyrite, potassium sulfate (K₂SO₄), and potassium chloride (KCl) of at least 1 wt % for a total weight of the body or at least or at least 2 wt % or at least 3 wt % or at least 4 wt % or at least 5 wt % or at least 6 wt % or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt %.

Item 29. The abrasive article of item 26, wherein the body includes a total content of pyrite, potassium sulfate (K₂SO₄), and potassium chloride (KCl) of not greater than 50 wt % for a total weight of the body or not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt %.

Item 30. The abrasive article of any one of items 1, 2, 3, 4, 5, and 6, wherein the first filler class includes a combination of pyrite and a blend of potassium sulfate (K₂SO₄) and potassium chloride (KCl), and wherein the first filler class includes a ratio (Cpy/Cb) of at least 0.1, wherein Cpy represents the content of pyrite in weight percent for a total weight of the body and Cb in represents the content of the blend of potassium sulfate and potassium chloride in weight percent for a total weight of the body, wherein the ratio (Cpy/Cb) is at least 0.2 or at least 0.3 or at least 0.4 or at least 0.5 or at least 0.6 or at least 0.7 or at least 0.8 or at least 0.9 or at least 1 or at least 1.1 or at least 1.2 or at least 1.3 or at least 1.4 or at least 1.5 or at least 1.6 or at least 1.7 or at least 1.8 or at least 1.9 or at least 2 or at least 2.2 or at least 2.5.

Item 31. The abrasive article of any one of items 1, 2, 3, 4, 5, and 6, wherein the first filler class includes a combination of pyrite and a blend of potassium sulfate (K₂SO₄) and potassium chloride (KCl), and wherein the first filler class includes a ratio (Cpy/Cb) of not greater than 10, wherein Cpy represents the content of pyrite in weight percent for a total weight of the body and Cb in represents the content of the blend of potassium sulfate and potassium chloride in weight percent for a total weight of the body, wherein the ratio (Cpy/Cb) is not greater than 10, wherein the ratio (Cpy/Cb) is not greater than 9.5 or not greater than 9 or not greater than 8.5 or not greater than 8 or not greater than 7.5 or not greater than 7 or not greater than 6.5 or not greater than 6 or not greater than 5.5 or not greater than 5 or not greater than 4.5 or not greater than 4 or not greater than 3.5 or not greater than 3 or not greater than 2.9 or not greater than 2.8 or not greater than 2.7 or not greater than 2.6 or not greater than 2.5 or not greater than 2 or not greater than 1.5 or not greater than 1 or not greater than 0.9 or not greater than 0.8 or not greater than 0.7 or not greater than 0.6 or not greater than 0.5 or not greater than 0.4 or not greater than 0.3 or not greater than 0.2 or not greater than 0.1.

Item 32. The abrasive article of any one of items 1, 2, 3, 4, 5, and 6, wherein the body includes a content of calcium carbonate (CaCO₃) of at least 0.1 wt % for a total weight of the body or at least or at least 0.2 wt % or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.1 wt % or at least 1.2 wt %.

Item 33. The abrasive article of any one of items 1, 2, 3, 4, 5, and 6, wherein the body includes a content of calcium carbonate (CaCO₃) of not greater than 10 wt % for a total weight of the body or not greater than 9 wt % or not greater than 8 wt % or not greater than 7 wt % or not greater than 6 wt % or not greater than 5 wt % or not greater than 4.5 wt % or not greater than 4 wt % or not greater than 3.5 wt % or not greater than 3 wt % or not greater than 2.5 wt % or not greater than 2 wt % or not greater than 1.9 wt % or not greater than 1.8 wt % or not greater than 1.7 wt %.

Item 34. The abrasive article of any one of items 1, 2, 3, 4, 5, and 6, wherein the first filler class includes a combination of pyrite, potassium sulfate (K₂SO₄), potassium chloride (KCl), and calcium carbonate (CaCO₃) as measured in weight percent for a total weight of the body.

Item 35. The abrasive article of item 34, wherein the first filler class includes a greater content of pyrite (Cpy) as measured in weight percent for a total weight of the body as compared to a content of calcium carbonate (Ccc) as measured in weight percent for a total weight of the body.

Item 36. The abrasive article of item 35, wherein the body includes a ratio (Cpy/Ccc) of at least 1, wherein the ratio (Cpy/Ccc) is at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7 or at least 8 or at least 9 or at least 10 or at least 11 or at least 12 or at least 13 or at least 14.

Item 37. The abrasive article of item 36, wherein the body includes a ratio (Cpy/Ccc) of not greater than 100, wherein the ratio (Cpy/Ccc) is not greater than 95 or not greater than 90 or not greater than 85 or not greater than 80 or not greater than 75 or not greater than 70 or not greater than 65 or not greater than 60 or not greater than 55 or not greater than 50 or not greater than 45 or not greater than 40 or not greater than 35 or not greater than 30 or not greater than 25 or not greater than 22 or not greater than 20 or not greater than 18 or not greater than 16.

Item 38. The abrasive article of item 34, wherein the first filler class includes a greater content of potassium sulfate (Cps) as measured in weight percent for a total weight of the body as compared to a content of calcium carbonate (Ccc) as measured in weight percent for a total weight of the body.

Item 39. The abrasive article of item 38, wherein the body includes a ratio (Cps/Ccc) of at least 1, wherein the ratio (Cps/Ccc) is at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7.

Item 40. The abrasive article of item 38, wherein the body includes a ratio (Cps/Ccc) of not greater than 20, wherein the ratio (Cps/Ccc) is not greater than 18 or not greater than 16 or not greater than 14 or not greater than 12 or not greater than 10 or not greater than 9 or not greater than 8 or not greater than 7 or not greater than 6 or not greater than 5.

Item 41. The abrasive article of item 38, wherein the first filler class includes a greater content of potassium chloride (Cpc) as measured in weight percent for a total weight of the body as compared to a content of calcium carbonate (Ccc) as measured in weight percent for a total weight of the body.

Item 42. The abrasive article of item 41, wherein the body includes a ratio (Cpc/Ccc) of at least 1, wherein the ratio (Cpc/Ccc) is at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7.

Item 43. The abrasive article of item 41, wherein the body includes a ratio (Cpc/Ccc) of not greater than 20, wherein the ratio (Cpc/Ccc) is not greater than 18 or not greater than 16 or not greater than 14 or not greater than 12 or not greater than 10 or not greater than 9 or not greater than 8 or not greater than 7 or not greater than 6 or not greater than 5.

Item 44. The abrasive article of item 34, wherein the first filler class includes a greater content of a blend of potassium sulfate and potassium chloride (Cb) as measured in weight percent for a total weight of the body as compared to a content of calcium carbonate (Ccc) as measured in weight percent for a total weight of the body.

Item 45. The abrasive article of item 44, wherein the body includes a ratio (Cb/Ccc) of at least 1, wherein the ratio (Cb/Ccc) is at least 1.1 or at least 1.2 or at least 1.3 or at least 1.4 or at least 1.5 or at least 1.6 or at least 1.7 or at least 1.8 or at least 1.9 or at least 2 or at least 3 or at least 4 or at least 5 or at least 6 or at least 7.

Item 46. The abrasive article of item 38, wherein the body includes a ratio (Cb/Ccc) of not greater than 20, wherein the ratio (Cb/Ccc) is not greater than 18 or not greater than 16 or not greater than 14 or not greater than 12 or not greater than 10 or not greater than 9 or not greater than 8 or not greater than 7 or not greater than 6 or not greater than 5.

Item 47. The abrasive article of any one of items 1, 3, 4, 5, and 6, wherein the second filler class includes basalt in a content within a range between 1 wt % and not greater than 30 wt % for a total weight of the body.

Item 48. The abrasive article of any one of items 2 and 47, wherein the body comprises a content of basalt of at least 2 wt % basalt for a total weight of the body or at least 2.2 wt % or at least 2.4 wt % or at least 2.6 wt % or at least 2.8 wt % or at least 3 wt % or at least 3.2 wt % or at least 3.4 wt % or at least 3.6 wt % or at least 3.8 wt % or at least 4 wt % or at least 4.2 wt % or at least 4.4 wt % or at least 4.6 wt %.

Item 49. The abrasive article of any one of items 1, 2, 3, 4, 5, and 6, wherein the second filler class comprises basalt, and wherein the basalt has an elongated shape.

Item 50. The abrasive article of item 49, wherein the basalt has an aspect ratio of length:width of at least 2:1 or at least 3:1 or at least 4:1 or at least 5:1 or at least 6:1 or at least 7:1 or at least 8:1 or at least 9:1 or at least 10:1 or at least 20:1 or at least 50:1 or at least 100:1.

Item 51. The abrasive article of item 49, wherein the basalt has an aspect ratio of length:width of not greater than 300:1 or not greater than 280:1 or not greater than 260:1 or not greater than 240:1 or not greater than 220:1 or not greater than 200:1 or not greater than 190:1 or not greater than 180:1 or not greater than 160:1.

Item 52. The abrasive article of item 49, wherein the basalt is in the form of a fibrous material.

Item 53. The abrasive article of item 49, wherein the basalt is in the form of bundled fibers.

Item 54. The abrasive article of item 49, wherein the basalt is in the form of entangled fibers.

Item 55. The abrasive article of any one of items 2 and 48, wherein the body comprises a content of basalt of not greater than 28 wt % for a total weight of the body or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6.5 wt %.

Item 56. The abrasive article of any one of items 1, 2, 4, 5, and 6, wherein the second filler class includes zinc sulfide (ZnS) in a content within a range between 1 wt % and not greater than 30 wt % for a total weight of the body.

Item 57. The abrasive article of any one of items 3 and 56, wherein the body comprises a content of zinc sulfide of at least 2 wt % for a total weight of the body or at least 2.2 wt % or at least 2.4 wt % or at least 2.6 wt % or at least 2.8 wt % or at least 3 wt % or at least 3.2 wt % or at least 3.4 wt % or at least 3.6 wt % or at least 3.8 wt % or at least 4 wt % or at least 4.2 wt % or at least 4.4 wt % or at least 4.6 wt % or at least 4.8 wt % or at least 5 wt % or at least 5.2 wt % or at least 5.4 wt % or at least 5.6 wt % or at least 5.8 wt % or at least 6 wt % or at least 6.2 wt % or at least 6.4 wt % or at least 6.6 wt % or at least 6.8 wt % or at least 7 wt % or at least 7.2 wt % or at least 7.4 wt % or at least 7.6 wt % or at least 7.8 wt % or at least 8 wt % or at least 8.2 wt % or at least 8.4 wt %.

Item 58. The abrasive article of any one of items 3 and 57, wherein the body comprises a content of zinc sulfide of not greater than 28 wt % for a total weight of the body or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt %.

Item 59. The abrasive article of any one of items 1, 2, 3, 5, and 6, wherein the second filler class includes barium sulfate (BaSO₄) in a content within a range between 1 wt % and not greater than 30 wt % for a total weight of the body.

Item 60. The abrasive article of any one of items 4 and 59, wherein the body comprises a content of barium sulfate (BaSO₄) of at least 2 wt % for a total weight of the body or at least 2.2 wt % or at least 2.4 wt % or at least 2.6 wt % or at least 2.8 wt % or at least 3 wt % or at least 3.2 wt % or at least 3.4 wt % or at least 3.6 wt % or at least 3.8 wt % or at least 4 wt % or at least 4.2 wt % or at least 4.4 wt % or at least 4.6 wt % or at least 4.8 wt % or at least 5 wt % or at least 5.2 wt % or at least 5.4 wt % or at least 5.6 wt % or at least 5.8 wt % or at least 6 wt % or at least 6.2 wt %.

Item 61. The abrasive article of any one of items 3 and 60, wherein the body comprises a content of barium sulfate (BaSO₄) of not greater than 28 wt % for a total weight of the body or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6.5 wt %.

Item 62. The abrasive article of any one of items 1, 2, 3, 4, and 6, wherein the second filler class includes potassium titanate (K₂O.nTiO₂ n=1-10) in a content within a range between 0.1 wt % and not greater than 30 wt % for a total weight of the body.

Item 63. The abrasive article of any one of items 5 and 62, wherein the body comprises a content of potassium titanate (K₂O.nTiO₂ n=1-10) of at least 0.2 wt % for a total weight of the body or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.1 wt % or at least 1.2 wt % or at least 1.3 wt % or at least 1.4 wt % or at least 1.5 wt %.

Item 64. The abrasive article of any one of items 5 and 62, wherein the body comprises a content of potassium titanate (K₂O.nTiO₂ n=1-10) of not greater than 28 wt % for a total weight of the body or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2.8 wt % or not greater than 2.6 wt % or not greater than 2.4 wt % or not greater than 2.2 wt % or not greater than 2 wt % or not greater than 1.9 wt % or not greater than 1.8 wt % or not greater than 1.7 wt % or not greater than 1.6 wt %.

Item 65. The abrasive article of any one of items 5 and 62, wherein the potassium titanate (K₂O.nTiO₂) is in the form of a fibrous material.

Item 66. The abrasive article of any one of items 5 and 62, wherein the potassium titanate (K₂O.nTiO₂) is in the form of bundled fibers.

Item 67. The abrasive article of any one of items 5 and 62, wherein the potassium titanate (K₂O.nTiO₂) is in the form of entangled fibers.

Item 68. The abrasive article of any one of items 5 and 62, wherein the potassium titanate (K₂O.nTiO₂) is in the form of a particulate having an average particle size within a range of 0.6 microns to 55 microns.

Item 69. The abrasive article of any one of items 1, 2, 3, 4, and 5, wherein the second filler class includes mullite in a content within a range between 1 wt % and not greater than 30 wt % for a total weight of the body.

Item 70. The abrasive article of any one of items 6 and 69, wherein the body comprises a content of mullite of at least 0.2 wt % for a total weight of the body or at least 0.3 wt % or at least 0.4 wt % or at least 0.5 wt % or at least 0.6 wt % or at least 0.7 wt % or at least 0.8 wt % or at least 0.9 wt % or at least 1 wt % or at least 1.1 wt % or at least 1.2 wt % or at least 1.3 wt % or at least 1.4 wt % or at least 1.5 wt % or at least 1.6 wt % or at least 1.7 wt % or at least 1.8 wt % or at least 1.9 wt % or at least 2 wt %.

Item 71. The abrasive article of any one of items 6 and 69, wherein the body comprises a content of mullite of not greater than 28 wt % for a total weight of the body or not greater than 26 wt % or not greater than 24 wt % or not greater than 22 wt % or not greater than 20 wt % or not greater than 18 wt % or not greater than 16 wt % or not greater than 14 wt % or not greater than 12 wt % or not greater than 11 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2.8 wt % or not greater than 2.6 wt % or not greater than 2.4 wt %.

Item 72. The abrasive article of any one of items 6 and 69, wherein the mullite is in the form of a fibrous material.

Item 73. The abrasive article of any one of items 6 and 69, wherein the mullite is in the form of bundled fibers.

Item 74. The abrasive article of any one of items 6 and 69, wherein the mullite is in the form of entangled fibers.

Item 75. The abrasive article of any one of items 1, 2, 3, 4, 5, and 6, wherein the bond material further comprises a filler material including chopped strand fibers, glass fibers, mineral wool, metal fiber, ceramic fiber, carbon fiber, aramid fiber, wollastonite, Frit, Talc, mica, montmorillonite, nature clay, and any combination thereof.

Item 76. The abrasive article of any one of items 1, 2, 3, 4, 5, and 6, further comprising a maximum linear thermal expansion ratio of not greater than 0.7% or not greater than 0.65% or not greater than 0.6 or not greater than 0.55% or not greater than 0.5% and greater than 0.

Item 77. The abrasive article of any one of items 1, 2, 3, 4, 5, and 6, wherein the abrasive particles include a material selected from the group of oxides, nitrides, carbides, borides silicides, silicates, superabrasives, minerals, monocrystalline, polycrystalline, amorphous, or a combination thereof.

Item 78. The abrasive article of any one of items 1, 2, 3, 4, 5, and 6, wherein the abrasive particles comprise alumina.

Item 79. The abrasive article of any one of items 1, 2, 3, 4, 5, and 6, wherein the abrasive particles consist essentially of alumina.

Item 80. The abrasive article of any one of items 1, 2, 3, 4, 5, and 6, wherein the body comprises at least 5 wt % and not greater than 90 wt % abrasive particles for the total weight of the body.

Item 81. The abrasive article of any one of items 1, 2, 3, 4, 5, and 6, wherein the bond material comprises a polymer.

Item 82. The abrasive article of any one of items 1, 2, 3, 4, 5, and 6, wherein the bond material comprises a resin.

Item 83. The abrasive article of any one of items 1, 2, 3, 4, 5, and 6, wherein the bond material comprises a phenolic resin.

Item 84. The abrasive article of any one of items 1, 2, 3, 4, 5, and 6, wherein the body comprises at least 1 wt % and not greater than 70 wt % bond material for the total weight of the body.

### EXAMPLES

### Example 1

Abrasive article samples A to F representative of embodiments herein and a conventional abrasive article sample (Con) were made. The samples included the same bond material and abrasive particles in similar weight contents. The samples differed in the filler compositions and contents. The compositions of all of the samples are summarized and include in Table 1 below.

TABLE 1
Compositions of Sample Con and Samples A to F

| Sample | | Con | A | B | C | D | E | F |
|---|---|---|---|---|---|---|---|---|
| Grain | Alumina SR1 | 57%- | 53%- | 53%- | 53%- | 53%- | 53%- | 53%- |
| | | 63% | 65% | 65% | 65% | 65% | 65% | 65% |
| Bond | Novolac | 3%- | 3%- | 3%- | 3%- | 3%- | 3%- | 3%- |
| | | 8% | 8% | 8% | 8% | 8% | 8% | 8% |
| | FeS₂ | 16%- | 16%- | 6%- | 16%- | 16%- | 6%- | 16%- |
| | | 21% | 21% | 13% | 21% | 21% | 13% | 21% |
| | Blend of KCl and | 4%- | 4%- | 4%- | 4%- | 4%- | 4%- | 0.00 |
| | K₂SO₄ | 10% | 10% | 10% | 10% | 10% | 10% | |
| | Lime | 0.5%- | 0.5%- | 0.5%- | 0.5%- | 0.5%- | 0.5%- | 0.5%- |
| | | 3.5% | 3.5% | 3.5% | 3.5% | 3.5% | 3.5% | 3.5% |
| | ZnS | 0.00 | 0.00 | 0.00 | 0.00 | 0.00 | 5%- | 0.00 |
| | | | | | | | 11% | |
| | BaSO₄ | 0.00 | 0.00 | 6%- | 0.00 | 0.00 | 0.00 | 0.00 |
| | | | | 11% | | | | |
| | Potassium titanate | 0.00 | 0.00 | 0.00 | 0.2%- | 0.00 | 0.00 | 0.00 |
| | whisker/powder | | | | 1.5% | | | |
| | Mullite fiber | 0.00 | 0.00 | 0.00 | 0.00 | 0.5%- | 0.00 | 0.00 |
| | | | | | | 3.5% | | |
| | KCl | 0.00 | 0.00 | 0.00 | 0.00 | 0.00 | 0.00 | 2.5%- |
| | | | | | | | | 8.5% |
| | Liquid Novolac | 0%- | 0%- | 0%- | 0%- | 0%- | 0%- | 0%- |
| | (Wt %) | 3% | 3% | 3% | 3% | 3% | 3% | 3% |
| | CSF | 2.5%- | 0.00 | 2.5%- | 2.5%- | 2.5%- | 2.5%- | 2.5%- |
| | | 8.5% | | 8.5% | 8.5% | 8.5% | 8.5% | 8.5% |
| | Basalt fiber | 0.00 | 3%- | 0.00 | 0.00 | 0.00 | 0.00 | 0.00 |
| | | | 9% | | | | | |

| | | | | | | | |
|---|---|---|---|---|---|---|---|
| Total (Wt %) | 100.00 | 100.00 | 100.00 | 100.00 | 100.00 | 100.00 | 100.00 |

The materials for forming Sample Con and Samples A to F were prepared. Novolac resins and fillers corresponding to each sample were mixed in the contents provided in Table 1 for 30 minutes to prepare the bond materials for each sample, and the bond materials were incubated for 4 to 12 hours before use. The abrasive grains in Table 1 were first mixed with liquid phenolic resin in a mixing bowl for 2 to 7 minutes or until all of the grains were wet and coated by the liquid phenolic resin. The wet abrasive grains were then combined with the bond materials prepared earlier and mixed for about 2 to 5 minutes, before CSF (glass fibers) or basalt fibers were added lastly and stirred for about 20 seconds to 1 minute to form the mixture for each sample. The mixture of each sample was poured into a mold, and hot pressed for 30 to 60 minutes at 140° C. to 200° C. with the load of 1000 to 1600 tons. The samples were removed from the molds and heat treated in a furnace at 150° C. to 250° C. for 15 hours to 25 hours. Before testing, the samples were cooled down in air to below 60° C.

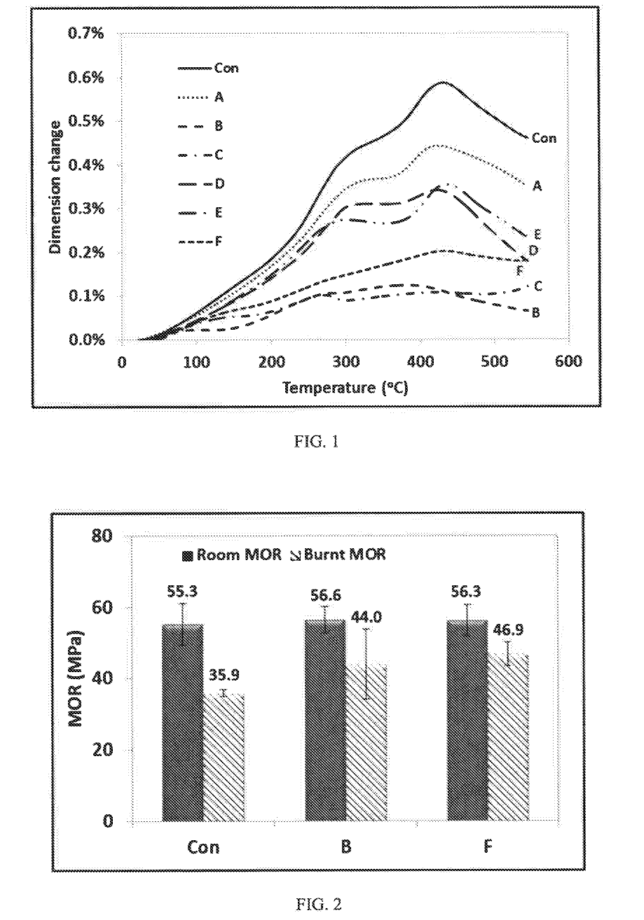

The linear thermal expansion of all the samples was measured using the TMA 4000 thermomechanical analyzer (PerkinElmer) during the temperature change from 20° C. to 550° C., and is included in FIG. 1. As illustrated, Sample Con demonstrated about 0.58% maximum linear thermal expansion ratio, while Sample A to F demonstrated 0.52%, 0.14%, 0.12%, 0.2%, 0.35%, and 0.2% maximum linear thermal expansion ratio, respectively.

### Example 2

A grinding test was performed on Samples Con, A, C, and E utilizing Hengshan grinder. Grinding was conducted on 304 stainless steel workpieces at the workpiece temperature of 100° C. to 550° C. The wheel speed was 80 m/s, and workpiece speed 60 m/min. Cross feed was 25 mm, and depth of cut was 1.0 mm. The relative grinding performance of the samples, included in Table 2, was determined by comparing the G-Ratios of each sample of Samples Con, A, C, and E to the G-Ratio of Sample Con. The relative grinding performance was an average of at least two samples having the same composition. Samples C and E demonstrated improved grinding performance compared to Sample Con.

TABLE 2
Relative Grinding Performance

| Sample | Con | A | C | E |
|---|---|---|---|---|
| Relative | 100% | 100% | 114% | 108% |
| Grinding | | | | |
| Performance | | | | |

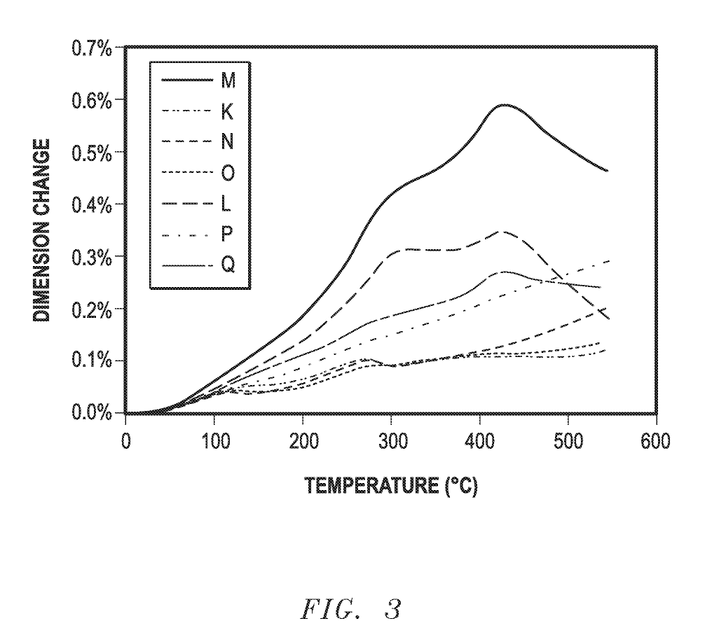

Two sets of Samples Con, B and F were subjected to modulus of rupture (MOR) tests under 20° C. and 450° C., respectively. The sets of samples were kept under 20° C. or 450° C. for 30 minutes and then tested on Instron 3367 with the load of 10 kN and at the speed of 1.27 mm/min. As illustrated in FIG. 2, Sample Con demonstrated MOR of 55.3 MPa at 20° C. and 35.9 MPa at 450° C. Sample B and F had similar MOR at 20° C., 56.6 MPA and 56.3 MPa, respectively, as compared to Sample Con, but improved MOR at 450° C. Sample B had MOR of 44.0 MPa, and Sample F had 46.9 MPa at 450° C.

### Example 3

Abrasive article samples G to L representative of embodiments herein were formed in the same manner as the samples of Example 1. The compositions of Samples G to L are included in Table 3 below.

TABLE 3
Compositions of Samples G to L

| Sample | | G | H | I | J | K | L |
|---|---|---|---|---|---|---|---|
| Grain | Alumina | 51%- | 62%- | 51%- | 51%- | 51%- | 51%- |
| | 92X | 57% | 68% | 57% | 57% | 57% | 57% |
| Bond | Novolac | 3%- | 3%- | 3%- | 3%- | 3%- | 3%- |
| | | 9% | 9% | 9% | 9% | 9% | 9% |
| | Pyrite | 19%- | 12%- | 13%- | 15%- | 17%- | 17%- |
| | | 25% | 18% | 19% | 21% | 23% | 23% |
| | KCl/K₂SO₄ | 6%- | 3%- | 3%- | 4%- | 5%- | 5%- |
| | | 12% | 9% | 9% | 10% | 11% | 11% |
| | Lime | 0.5%- | 0.5%- | 0.5%- | 0.5%- | 0.5%- | 0.5%- |
| | | 3.5% | 3.5% | 3.5% | 3.5% | 3.5% | 3.5% |
| | ZnS | 0.00 | 0.00 | 5%- | 0.00 | 0.00 | 0.00 |
| | | | | 11% | | | |
| | BaSO₄ | 0.00 | 0.00 | 0.00 | 3%- | 0.00 | 0.00 |
| | | | | | 9% | | |
| | PTW | 0.00 | 0.00 | 0.00 | 0.00 | 0.5%- | 0.00 |
| | | | | | | 4% | |
| | Mullite | 0.00 | 0.00 | 0.00 | 0.00 | 0.00 | 0.5%- |
| | fiber | | | | | | 5% |
| | Resole | 0.5%- | 0.5%- | 0.5%- | 0.5%- | 0.5%- | 0.5%- |
| | (Wt %) | 4% | 4% | 4% | 4% | 4% | 4% |
| | NSG | 0.00 | 0.00 | 3.5%- | 3.5%- | 3.5%- | 3.5%- |
| | | | | 9.5% | 9.5% | 9.5% | 9.5% |
| | Basalt | 3%- | 2%- | 0.00 | 0.00 | 0.00 | 0.00 |
| | fiber | 9% | 8% | | | | |

| | | | | | | |
|---|---|---|---|---|---|---|
| Total (Wt %) | 100.00 | 100.00 | 100.00 | 100.00 | 100.00 | 100.00 |

### Example 4

Abrasive article samples were formed having the compositions included in Table 4 below. Sample M was used as a reference sample. Samples K, L, and N to Q were representative of embodiments herein.

TABLE 4
Compositions of Samples K to Q

| Sample | | K | L | M | N | O | P | Q |
|---|---|---|---|---|---|---|---|---|
| Grain | Alumina 92X | 51%-57% | 51%-57% | 51%-57% | 51%-57% | 51%-57% | 51%-57% | 51%-57% |
| Bond | Novolac | 3%-9% | 3%-9% | 3%-9% | 3%-9% | 3%-9% | 3%-9% | 3%-9% |
| | Pyrite | 17%-23% | 17%-23% | 19%-25% | 13%-19% | 13%-19% | 13%-19% | 13%-19% |
| | KCl/K₂SO₄ | 5%-11% | 5%-11% | 6%-12% | 3%-9% | 3%-9% | 3%-9% | 3%-9% |
| | Lime | 0.5%-3.5% | 0.5%-3.5% | 0.5%-3.5% | 0.5%-3.5% | 0.5%-3.5% | 0.5%-3.5% | 0.5%-3.5% |
| | ZnS | 0 | 0 | 0 | 5%-11% | 5%-11% | 5%-11% | 5%-11% |
| | BaSO₄ | 0 | 0 | 0 | 0 | 0 | 0 | 0 |
| | PTW | 0.5%-4% | 0 | 0 | 0.5%-4% | 0.5%-4% | 0 | 0 |
| | Mullite fiber | 0 | 0.5%-5% | 0 | 0 | 0 | 0.5%-5% | 0.5%-5% |
| | Resole | 0.5%-4% | 0.5%-4% | 0.5%-4% | 0.5%-4% | 0.5%-4% | 0.5%-4% | 0.5%-4% |
| | (Wt %) | | | | | | | |
| | NSG | 3.5%-9.5% | 3.5%-9.5% | 3%-9% | 3.5%-9.5% | 0 | 3.5%-9.5% | 0 |
| | Basalt fiber | 0 | 0 | 0 | 0 | 3.5%-9.5% | 0 | 3.5%-9.5% |

| | | | | | | | |
|---|---|---|---|---|---|---|---|
| Total (Wt %) | 100 | 100 | 100 | 100 | 100 | 100 | 100 |

The materials for forming Samples K to Q were prepared. Novolac resins and fillers corresponding to each sample were mixed in the contents provided in Table 4 for 30 minutes to prepare the bond materials for each sample, and the bond materials were incubated for 4 to 12 hours before use. The abrasive grains in Table 4 were first mixed with liquid phenolic resin in a mixing bowl for 2 to 7 minutes or until all of the grains were wet and coated by the liquid phenolic resin. The wet abrasive grains were then combined with the bond materials prepared earlier and mixed for about 2 to 5 minutes, before NSG (glass fibers) or basalt fibers were added lastly and stirred for about 20 seconds to 1 minute to form the mixture for each sample. The mixture of each sample was poured into a mold, and hot pressed for 30 to 60 minutes at 140° C. to 200° C. with the load of 1000 to 1600 tons. The samples were removed from the molds and heat treated in a furnace at 150° C. to 250° C. for 15 hours to 25 hours. Before testing, the samples were cooled down in air to below 60° C.

The linear thermal expansions of all the samples was measured using the TMA 4000 thermomechanical analyzer (PerkinElmer) during the temperature change from 20° C. to 550° C., and are included in FIG. 3. As illustrated, Sample M demonstrated about 0.59% maximum linear thermal expansion ratio, while Sample K, L, and N to Q demonstrated 0.13%, 0.34%, 0.19%, 0.13%, 0.29%, and 0.27% maximum linear thermal expansion ratio, respectively.

The present embodiments represent a departure from the state of the art. Notably, certain embodiments herein may include a filler composition including fillers from a first filler class and second filler class. Some embodiments may utilize certain contents of fillers. Moreover, certain embodiments may utilize relative contents of certain fillers relative to each other, which may facilitate improved performance. Unexpectedly, certain abrasive articles of the embodiments herein may have a reduced volumetric expansion for temperatures between 20° C. to 550° C. and may also have improved mechanical properties (e.g., MOR), particular under high temperatures, as compared to conventional abrasive articles. Improved heat resistance and performance can make the abrasive article of embodiments herein particularly suitable for operations under high temperatures, such as applications of high temperature grinding.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implement using digital circuits, and vice versa.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive. Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

What is claimed is:

1. An abrasive article comprising:
a body including:
a bond material;
abrasive particles contained within the bond material; and
a filler composition contained within the bond material, wherein the filler composition includes at least one filler from a first filler class and at least one filler from a second filler class, wherein:
the first filler class includes pyrite, potassium sulfate (K₂SO₄), potassium chloride (KCl), and lime (CaO), and
the second filler class includes basalt, mullite, zinc sulfide (ZnS), barium sulfate (BaSO₄), potassium titanate (K₂O.nTiO₂ n=1-10) or a combination thereof.

2. The abrasive article of claim 1, wherein the first filler class includes a content of pyrite of at least 2 wt % and not greater than 40 wt % for a total weight of the body.

3. The abrasive article of claim 1, wherein the first filler class includes a combination of pyrite and potassium sulfate (K₂SO₄), and wherein the first filler class includes a greater content of pyrite (Cpy) as measured in weight percent for a total weight of the body as compared to a content of potassium sulfate (Cps).

4. The abrasive article of claim 1, wherein the first filler class includes pyrite and a blend of potassium sulfate (K₂SO₄) and potassium chloride (KCl).

5. The abrasive article of claim 1, wherein the first filler class includes a combination of pyrite, potassium sulfate (K₂SO₄), potassium chloride (KCl), and lime (CaO) as measured in weight percent for a total weight of the body.

6. The abrasive article of claim 1, wherein the at least one filler from the second filler class includes basalt in a content within a range between 1 wt % and not greater than 30 wt % for a total weight of the body.

7. The abrasive article of claim 6, wherein the basalt has an elongated shape.

8. The abrasive article of claim 6, wherein the basalt is in a form of a fibrous material.

9. The abrasive article of claim 6, wherein the basalt is in a form of bundled fibers, entangled fibers, or any combination thereof.

10. The abrasive article of claim 1, wherein the at least one filler from the second filler class includes zinc sulfide (ZnS) in a content within a range between 1 wt % and not greater than 30 wt % for a total weight of the body.

11. The abrasive article of claim 1, wherein the at least one filler from the second filler class includes barium sulfate (BaSO₄) in a content within a range between 1 wt % and not greater than 30 wt % for a total weight of the body.

12. The abrasive article of claim 1, wherein the at least one filler from the second filler class includes mullite in a content within a range between 0.2 wt % and not greater than 30 wt % for a total weight of the body.

13. The abrasive article of claim 11, wherein the mullite is in a form of a fibrous material.

14. An abrasive article comprising:
a body including:
a bond material;
abrasive particles contained within the bond material; and
a filler composition contained within the bond material, wherein the filler composition comprises:
at least one filler from a first filler class including pyrite, potassium sulfate (K₂SO₄), potassium chloride (KCl), lime (CaO), or a combination thereof, and
a second filler class including potassium titanate (K₂O.nTiO₂ n=1-10) in a content within a range between at least 0.1 wt % and not greater than 30 wt % for a total weight of the body.

15. The abrasive article of claim 14, wherein the potassium titanate (K₂O.nTiO₂) is in the form of a fibrous material.

16. The abrasive article of claim 14, wherein the content of the potassium titanate (K₂O.nTiO₂) is within a range between at least 1 wt % and not greater than 8 wt %.

17. The abrasive article of claim 14, wherein the second filler class further includes zinc sulfide (ZnS).

18. The abrasive article of claim 17, wherein the second filler class further includes basalt.

19. The abrasive article of claim 15, wherein the first filler class includes a combination of pyrite, potassium sulfate (K₂SO₄), potassium chloride (KCl), and lime (CaO) as measured in weight percent for a total weight of the body.

20. The abrasive article of claim 15, comprising a maximum linear thermal expansion ratio of not greater than 0.7%.
